(19) United States
(12) Patent Application Publication
(10) Pub. No.: US 2002/0074063 A1
(43) Pub. Date: Jun. 20, 2002

(54) Method and apparatus for dissecting a log

(76) Inventors: Hans Dietz, Ammerbuch (DE); Jean Gunnar Bergvall, Altotting (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/003,802

(22) Filed: Nov. 2, 2001

(30) Foreign Application Priority Data
Nov. 3, 2000 (DE) 100 55 298.6

(51) Int. Cl. B27B 1/00

(52) U.S. Cl. 144/376; 144/379

(57) ABSTRACT

The invention is related to a method and an apparatus for dissecting a log into boards, the log being adapted to be displaced on a longitudinal conveyor in a longitudinal direction. For determining the board length, it is prior art to cut the log at its periphery by means of a cross-cut saw prior to dissecting the log into boards. As the cross-cut saw is stationary, the determination of the cutting depth is effected by displacing the log transversally. In the case of larger cutting depths, the log must be displaced back in the transversal direction after effecting the cross-cut so that a board of desired thickness may then subsequently be dissected from the log by means of a band saw. During that back displacement, it may happen that the log slips on the longitudinal conveyor so that the dimensional accuracy is lost. The invention solves this problem by displacing the band saw blade at least as far away from the log in the transversal direction prior to the working of the log, so that the log may be displaced past the band saw blade without coming in contact with the band saw blade.

### FIELD OF THE INVENTION

The invention is, generally, related to the field of processing logs, as is done in sawmills or like installations.

More specifically, the invention is related to a method for dissecting a log, the log being adapted to be reciprocally displaced on a longitudinal conveyor in a longitudinal direction, the method comprising the steps of:

a) displacing the log on the longitudinal conveyor in a transversal direction extending under right angles relative to the longitudinal direction towards a working tool, until the log assumes a transversal position relative to the working tool corresponding to a predetermined working depth;

b) working the log from its periphery with the working tool; and

c) dissecting the log in the longitudinal direction by feeding the log in several passes through a band saw blade in the longitudinal direction.

The invention, further, is related to an apparatus for dissecting a log comprising:

a) a longitudinal conveyor on which a log may be displaced reciprocally in a longitudinal direction;

b) a transversal conveyor arranged on the longitudinal conveyor for displacing the log on the longitudinal conveyor in a transversal direction extending under right angles relative to the longitudinal direction;

c) a working tool for working the log from its periphery down to a predetermined working depth, the working depth being adapted to be set by displacing the transversal conveyor in the transversal direction; and

d) a band saw blade for dissecting the log in the longitudinal direction by feeding the log in several passes through the band saw blade in the longitudinal direction.

### BACKGROUND OF THE INVENTION

For dissecting logs into boards within sawmill installations, it is customary to secure the logs first on a longitudinal conveyor on which the logs may be conveyed in a longitudinal direction and to subsequently feed the logs through a band saw blade in several passes by stepwise increasing a lateral displacement of the log relative to the band saw blade. The band saw blade is usually a part of a stationary band saw assembly. For being able to stepwise displace the logs on the longitudinal conveyor, a transversal conveyor is used that shifts the logs on the longitudinal conveyor in a transversal direction extending under right angles to the longitudinal direction, while maintaining the longitudinal extension of the logs.

Considering that the boards which would be generated accordingly would have the length of the log, it is necessary to apply cross-cuts either after or prior to the dissecting for making boards of a nominal length. In the latter case, the log, however, is not entirely cross-cut in the transversal direction, but cross-cuts are applied in predetermined intervals along the length of the logs corresponding to the desired board length. The cross-cuts extend in the transversal direction and have a predetermined depth which, conventionally, corresponds to an integer multiple of the desired board thickness.

Prior art installations comprise a cross-cut saw for applying the cross-cuts. The cross-cut saw is conventionally positioned along the trajectory of displacement of the longitudinal conveyor. The cross-cut saw is provided with a circular saw blade which is displaceable in a vertical direction through the log. Due to the fact that the cross-cut saw is stationary, the determination of the cross-cut position in a longitudinal direction as well as of the cross-cut depth, the logs must be exactly positioned relative to the cross-cut saw. The setting of the cross-cut position in the longitudinal direction is effected by displacing the log on the longitudinal conveyor. The cross-cut depth is set by displacing the log on the longitudinal conveyor in the transversal direction by means of the transversal conveyor, until the log has assumed a transversal position corresponding to a predetermined cross-cut depth. Considering that normally all cross-cuts to be applied have the same depth, the transversal or lateral position of the log must only be determined once by means of the transversal conveyor. The individual cross-cuts are then effected one after the other by letting the circular saw go through the log in a first longitudinal position until it comes out of engagement with the log and by then advancing the longitudinal conveyor with the log to the second longitudinal position in which the circular saw blade again goes through the log, etc.

For feeding-in the log by means of the lateral conveyor, it is mandatory that the log is not in a position besides the band saw blade but in an offset position in the longitudinal direction instead. Otherwise, the log would contact the band saw blade during feeding-in. As a consequence, the distance between the band saw blade and the cross-cut saw must be at least one log length for avoiding a contact between the log and the band saw blade during the lateral feeding-in at arbitrary longitudinal positions of the cross-cuts.

When all cross-cuts have been applied, the prior art displaces the log by means of the transversal conveyor again in the transversal or lateral direction away from the cross-cut saw for bringing the log into the correct transversal position for then effecting the first longitudinal saw cut. Without this retraction movement, the first board would have a thickness corresponding to the cutting depth of the cross-cuts.

Transversal conveyors of conventional installations have two or more clamping blocks with claw-type jaws to clamp the log therebetween. The clamping blocks are adapted to be displaced on the longitudinal conveyor in a direction transversal to the longitudinal direction, so that the log being clamped between the clamping blocks may also be displaced in the transversal direction as described above. However, the log weight is not supported by the clamping block jaws but mostly rests on the longitudinal conveyor support. As a consequence, the log may be shifted on that support during the lateral displacement.

It has now been found out that when the log that had first been fed-in in a lateral direction is then again displaced back in an opposite sense on the support, after all cross-cuts have been effected, the log might have slid within the clamping blocks in spite of a careful clamping between the jaws thereof or may even have become loose from the clamping. The reason for that is that due to the high weight of the log resting on the longitudinal conveyor support, relatively high frictional forces are generated between the log and the support which, during the shifting of the log on the support, effect a torque on the log. If the direction of displacement is inverted, the torque is also inverted so that the log may slide between the clamping block jaws or may even become entirely loose. On the other hand, a constant fixation of the log between the clamping blocks is a prerequisite for effecting the working on the log while maintaining dimensional precision so that the afore-mentioned effects that might occur during the displacement of the log in the transversal direction must be considered as malfunctions disturbing the normal course of operation in a sawmill.

The problems mentioned before do not only occur in connection with effecting cross-cuts but also in other situations when the log is worked from its periphery by means of other working tools prior to the effecting of longitudinal cuts down to a predetermined working depth, for example by nicking, profiling, chipping, or otherwise.

German disclosure document DE 198 28 238 A1 discloses an apparatus and a method for dissecting logs comprising two or more band saw assemblies having each band saw blades being toothed on opposite sides and being arranged side-by-side along the direction of displacement of a longitudinal conveyor. In a transversal direction extending under right angles thereto, the two band saw assemblies are offset from each other by one board thickness so that during the feeding of the log through the two band saw assemblies, two boards are cut away. After each feeding-through, the two band saw assemblies are advanced towards the log by means of an appropriate displacement unit, the advancement being made reciprocally such that the offset between the two band saw assemblies is inverted in the transversal direction. Accordingly, during a subsequent feeding-through of the log on the longitudinal conveyor, again two boards are simultaneously cut away from the log. The reciprocating advancement of the band saw assemblies is then repeated during each subsequent inversion of displacement of the longitudinal conveyor. Additionally or as an alternative, the log may also be displaced in the transversal direction by means of a transversal conveyor.

It is, therefore, an object of the present invention to improve a method and an apparatus of the type specified at the outset, such that the attachment of the log on the longitudinal conveyor is secured as best as can be when the log is worked from its periphery down to a predetermined working depth by means of a working tool, in particular by means of a cross-cut saw prior to the application of longitudinal cuts.

### SUMMARY OF THE INVENTION

According to the invention, these and other objects are solved by a method for dissecting a log, the log being adapted to be reciprocally displaced on a longitudinal conveyor in a longitudinal direction, the method comprising the steps of:

a) displacing the log on the longitudinal conveyor in a transversal direction extending under right angles relative to the longitudinal direction towards a working tool, until the log assumes a transversal position relative to the working tool corresponding to a predetermined working depth;

b) before or simultaneously with the step of displacing the log on the longitudinal conveyor, displacing the band saw blade at least as much away from the log in the transversal direction that the log may be displaced on the longitudinal conveyor past the band saw blade without coming in contact with the band saw blade;

c) working the log from its periphery with the working tool; and

d) dissecting the log in the longitudinal direction by feeding the log in several passes through a band saw blade in the longitudinal direction.

The object is, further, solved by an apparatus for dissecting a log, as specified at the outset, the apparatus comprising:

a) a longitudinal conveyor on which a log may be displaced reciprocally in a longitudinal direction;

b) a transversal conveyor arranged on the longitudinal conveyor for displacing the log on the longitudinal conveyor in a transversal direction extending under right angles relative to the longitudinal direction;

c) a working tool for working the log from its periphery down to a predetermined working depth, the working depth being adapted to be set by displacing the transversal conveyor in the transversal direction;

d) a band saw blade for dissecting the log in the longitudinal direction by feeding the log in several passes through the band saw blade in the longitudinal direction;

e) means for displacing the band saw blade in the transversal direction; and

f) a control unit for controlling the longitudinal conveyor, the transversal conveyor, the working tool and the band saw blade, the control unit being configurated such that it displaces the band saw blade before or simultaneously with the displacement of the log on the longitudinal conveyor towards the working tool at least as much away from the log in the transversal direction that the log may be displaced on the longitudinal conveyor past the band saw blade without coming in contact with the band saw blade.

The object underlying the invention is thus entirely solved.

Instead of taking further measures for anchoring the log on the longitudinal conveyor support, the invention has selected a different approach. Accordingly, it may be ensured in a surprisingly simple manner that the log must not be displaced back again, prior to the effecting of longitudinal cuts, in order to obtain the desired board thickness. Instead, the log remains in its front transversal position into which it has been brought for effecting the cross-cuts or the like, wherein the band saw blade is retracted by the necessary distance for giving way for the log.

Considering that the band saw blade is displaced in a transversal direction towards the working tool prior to or simultaneously with displacement of the log on the longitudinal conveyor, the working tool may be positioned in the direct vicinity of the band saw blade. The band saw blade namely gives way in good time so that a contact between the log and the band saw blade is already avoided during the transversal feeding-in of the log. The entire installation, thus, becomes substantially more compact which, inter alia, also reduces the necessary displacement time intervals on the longitudinal conveyor.

During the subsequent dissection of the log in boards after the working by means of the working tools, the log may be displaced as far towards the band saw in a transversal direction prior to each pass aver dissecting log d) that during the feeding of the log the saw blade dissects a board of predetermined thickness from the log. After displacing the log in a transversal direction after displacing step a), the log is, accordingly, further advanced stepwise in the same direction towards the band saw blade for bringing the log into the correct transversal position for cutting the boards away.

In a predetermined embodiment of the invention, however, it is preferred when prior to each pass the band saw blade after step d) is displaced as much towards the log in the transversal direction that during the feeding of the log through the band saw blade, a board of a predetermined thickness is dissected from the log.

By doing so, the number of necessary displacement steps of the logs in the transversal direction is further reduced. It should be mentioned at this instance that the term “boards” in the context of the present invention should be understood to also comprise beams and other like items that may be manufactured from logs by applying cuts in the longitudinal and in the transversal direction.

Another preferred embodiment of the invention provides that after each dissecting of a board, the band saw blade is displaced as much away from the log in the transversal direction that the log may be moved on the longitudinal conveyor past the band saw blade without coming in contact with the band saw blade.

According to this embodiment, it is no more necessary to displace the log back in a transversal direction away from the band saw blade by a short distance for ensuring that during the back movement of the longitudinal conveyor past the band saw blade, there is no contact between the cutting edge and the band saw blade. In connection with the afore-mentioned features it becomes, therefore, possible to displace the log on the longitudinal conveyor only one time in a transversal direction, namely for determining the working depth of the working tool. The transversal positioning between the band saw blade and the log, which is necessary during the dissection of the log in boards is, accordingly, only effected by displacing the band saw blade in a transversal direction.

In still another preferred embodiment of the invention, the band saw blade is toothed on both sides in the longitudinal direction, such that each longitudinal forward and backward movement configurates a pass in which a board is dissected from the log.

By using this feature known per se, the number of dissected boards per time unit may be almost doubled. In a preferred embodiment of the inventive apparatus, the control unit comprises a computer unit and a memory means with a computer program stored therein, the computer program being configured such that the apparatus executes a method with method steps a) through d) mentioned above, when the computer program is loaded from the memory means into the computer unit.

Such a programmed control unit may be handled much simpler and in a much more flexible manner as compared to hard-wired control units.

The displacement of the band saw blade in a transversal direction may, for example, be effected by deflecting the band saw blade by means of additional deflection rollers which are adapted to be displaced in the transversal direction.

However, it is particularly preferred when the band saw blade is an integral portion of a band saw assembly which, as a whole, may be displaced in the transversal direction.

This has the advantage that conventionally used band saw assemblies may be incorporated without bigger modifications. One has only to take care that the band saw assembly be installed such as to be displaced in a transversal direction and be provided with an appropriate electrical or hydraulic drive unit.

It goes without saying that the features mentioned before and those that will be mentioned hereinafter are not only to be understood in the particularly given combination, but also in other combinations or alone without leaving the scope of the present invention.

### BRIEF DESCRIPTION OF THE DRAWINGS

An embodiment of the invention is shown in the drawing and will be explained in further detail along with the subsequent description.

FIG. 1 shows a highly schematic top plan view on an embodiment of an installation according to the present invention, in a first operational position;

FIG. 2a shows a side elevational view of the installation of FIG. 1, however, without the band saw assembly of FIG. 1 that has been omitted for the sake of clarity;

FIG. 2b is a side elevational view of the band saw assembly not shown in FIG. 2a;

FIGS. 3-7 show further operational positions of the installation shown in FIG. 1 where, for the sake of clarity, the control unit shown in FIG. 1 is not again shown.

### DETAILED DESCRIPTION OF THE PREFERRED EMBODIMENTS

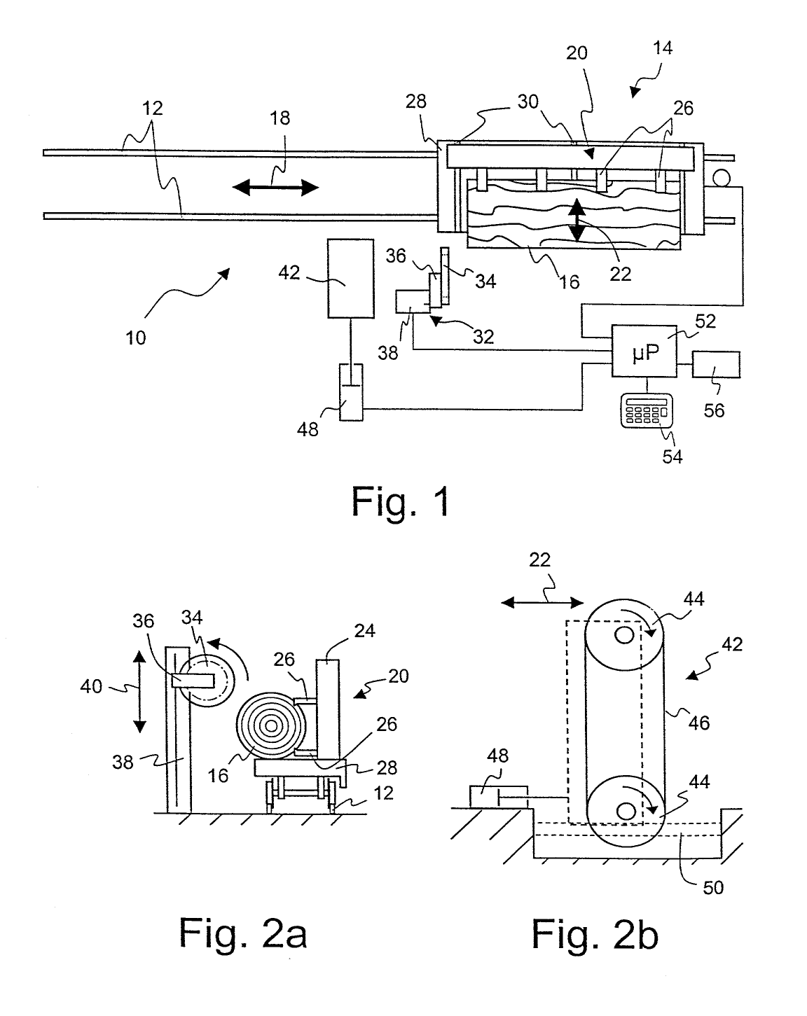

In FIG. 1, an embodiment of a dissecting installation according to the present invention is shown in a top plan view and is indicated as a whole by reference numeral 10. Dissecting installation 10 is a part of a sawmill in which logs are debarked, dissected in boards, planks, beams and the like, the boards are subsequently stacked and also packed, as the case may be.

Dissecting installation or apparatus 10 comprises two rails 12 configurating a track. A longitudinal conveyor 14 is adapted to be displaced along the track reciprocally along a longitudinal direction indicated by an arrow 12, when a log 16 is secured thereon. For that purpose, dissection installation 10 is provided with a chain drive or the like (not shown in FIG. 1) for longitudinal conveyor 14.

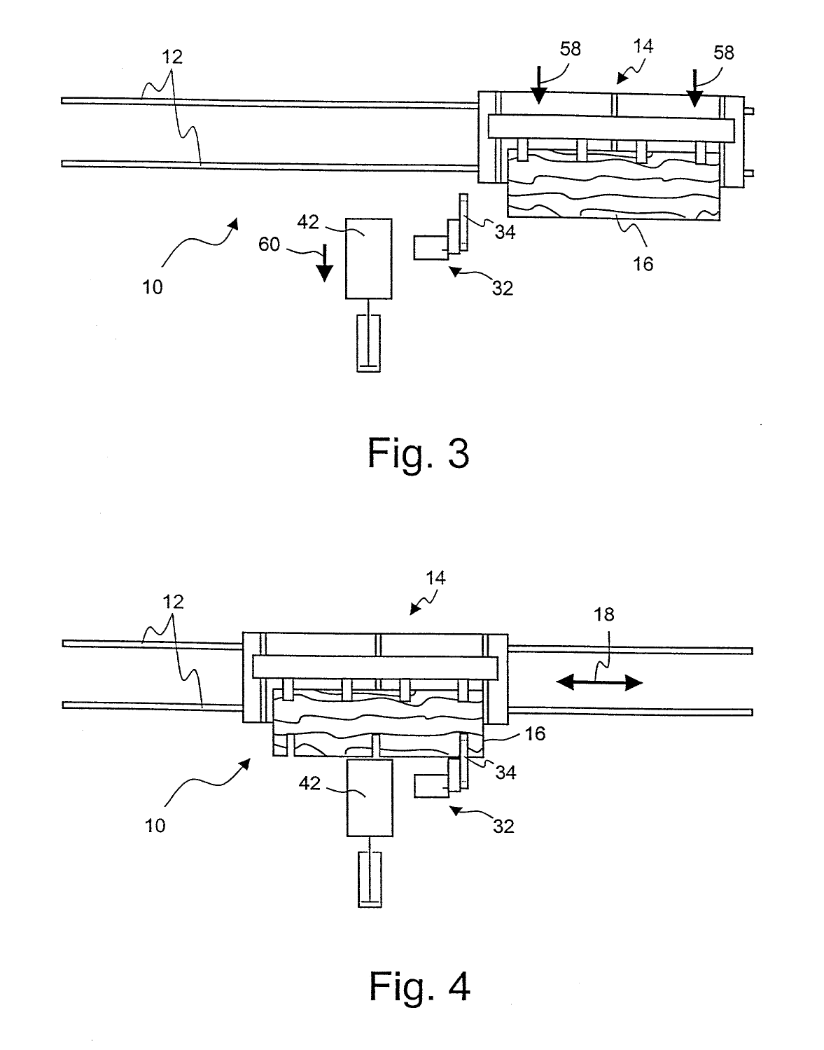

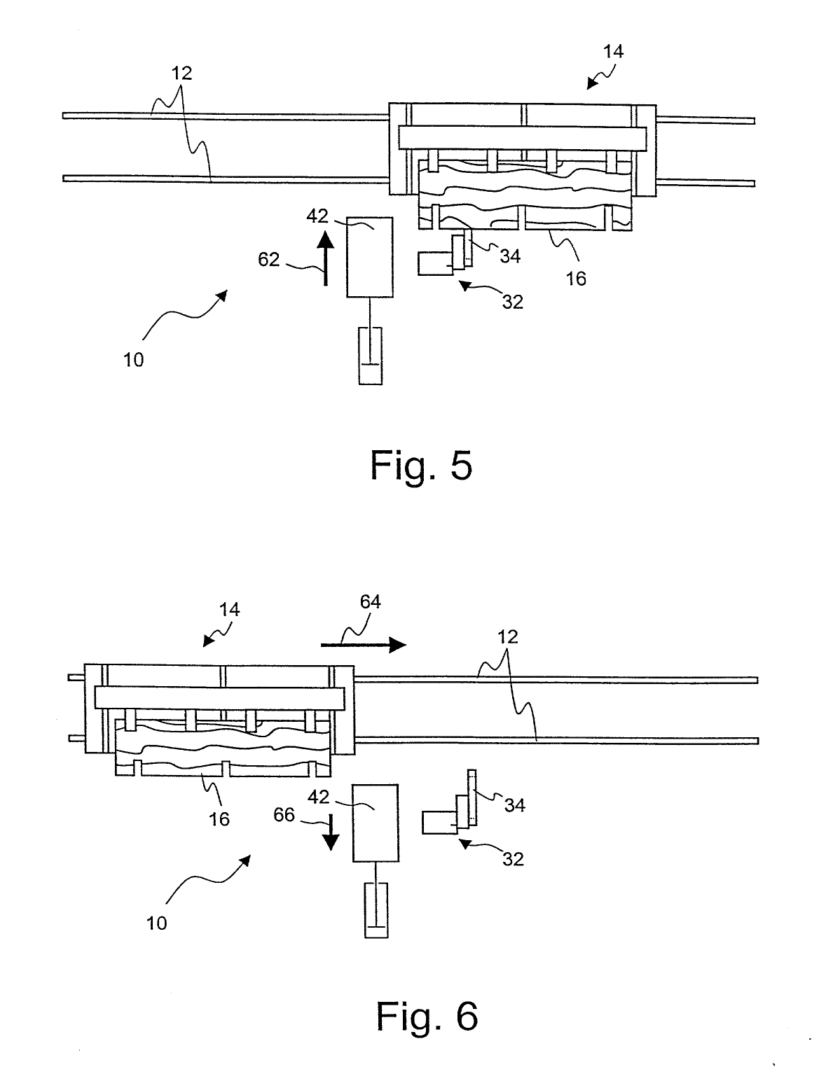

A transversal conveyor 20 is provided on longitudinal conveyor 14 for enabling a transversal or lateral displacement of log 16 on longitudinal conveyor 14 in a transversal direction indicated by an arrow 22. As may easily be seen from the side elevational view of FIG. 2a, transversal conveyor 20 comprises a rear wall 24 with a plurality of clamping blocks on a front surface thereof, wherein each clamping block is provided with two jaws 26 arranged above each other and adapted to be displaced in a vertical direction. The terminal ends of jaws 26 are provided with claws for clamping log 16 therebetween when jaws 26 are advanced towards each other by means of a drive unit (not shown). As becomes apparent from FIG. 2a, log 16 essentially rests on a support 28 of longitudinal conveyor 14.

Transversal guides 30 are embedded in support 28 of longitudinal conveyor 14. Rear wall 24 of transversal conveyor 20 may be displaced thereon, i.e. on longitudinal conveyor 14 in the transversal direction 22. During such a transversal or lateral movement of rear wall 24, log 16 being clamped between jaws 26 will likewise be shifted over support 28 of longitudinal conveyor 14 in the transversal direction 22.

FIGS. 1 and 2a, further, schematically show a working tool being a cross-cut saw 32 in the illustrated embodiment. Cross-cut saw 32 comprises a circular saw blade 34 being attached to an arm 36 on an upright 38. Arm 36 together with circular saw blade 34 may be displaced on upright 38 in a vertical direction as indicated by an arrow 40. Thereby, vertical cuts may be applied to log 16 at its periphery, when circular saw blade 34 is guided through log 16 in the vertical direction 40.

Finally, FIG. 1, further, shows a band saw assembly 42, the basic design of which becoming apparent from the side elevational view in FIG. 2b. Band saw assembly 42 has two rollers 44 disposed one above the other. A closed-loop band saw blade 46 is guided around rollers 44 under tension. Band saw assembly 42 may be displaced in the transversal direction 22 by means of a hydraulic drive 48. For that purpose, band saw assembly 42 at its bottom is provided with wheels (not shown in the drawing) guided on guide rails 50 extending in the transversal direction 22.

For controlling longitudinal conveyor 14, transversal conveyor 20, cross-cut saw 32 as well as hydraulic drive 48, a control unit is provided comprising a computer unit 52 as well as an input/output unit 54 connected therewith. Computer unit 52 has a memory 56 associated thereto in which a computer program is stored which, when loaded into computer unit 52, controls the coaction of the above-mentioned components of dissecting installation 10.

The operation of dissecting installation 10 will now be described with reference to the operational positions shown in FIGS. 1 and 3 through 7.

The operational position shown in FIG. 1 corresponds to an initial position that is assumed after log 16 has been secured on longitudinal conveyor 14. In that initial position, log 16 is still positioned as far away from circular saw blade 34 of cross-cut saw 32 that a cut through log 16 in the transversal direction 22 is impossible when circular saw blade 34 is displaced in the vertical direction 40.

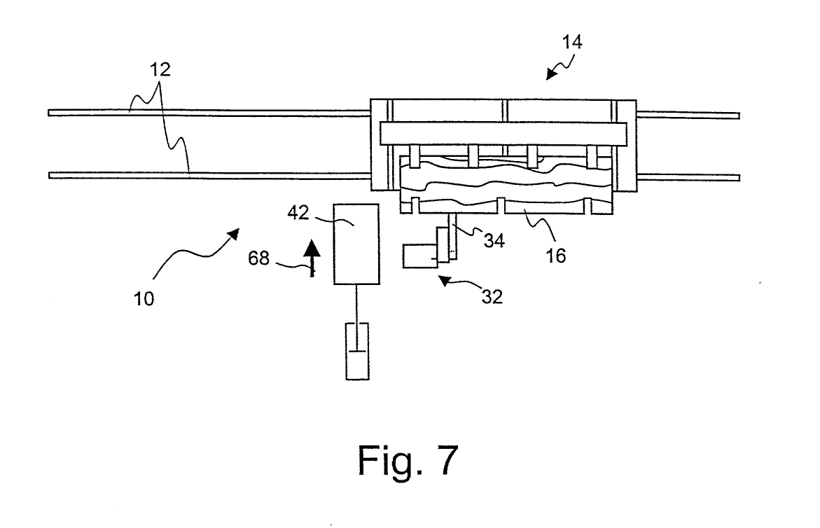

Therefore, as shown in FIG. 3, log 16 is advanced on longitudinal conveyor 14 in the direction of arrows 58 towards circular saw blade 34, namely as far until log 16 assumes a transversal position relative to circular saw blade 34 corresponding to a predetermined cutting depth. If, in that situation, circular saw blade 34 assumes the uppermost stop position shown in FIG. 2a or a corresponding lowermost stop position, log 16 may be displaced past cross-cut saw 32 on longitudinal conveyor 14 until the desired longitudinal position is reached, at which a cut shall be applied by means of cross-cut saw 32. When this position is assumed, longitudinal conveyor 14 is stopped and circular saw blade 34 is now guided through the periphery of log 16 in the vertical direction 40. After having applied this first cut, further cuts may be applied subsequently, by advancing longitudinal conveyor 14 by an appropriate distance while circular saw blade 34 is in one of the afore-mentioned stop positions and guiding circular saw blade 34 then anew in a vertical direction through the periphery of log 16.

In order to enable log 16 to be guided past band saw blade 46, band saw assembly 42 is displaced away from log 16 in the direction of an arrow 60. Preferably, this is made synchronously with the displacement of log 16 towards cross-cut saw 32. Band saw assembly 42 must then be retracted at least as far in the direction of arrow 60 that log 16 may be displaced on longitudinal conveyor 14 past band saw blade 46 without coming in contact with the latter.

After having effected the last cross-cut (see FIG. 4), longitudinal conveyor 14 is displaced back again towards its initial position (see FIG. 5). Band saw assembly 42 is now advanced towards log 16 in the direction of an arrow 62, namely as far as during a subsequent feeding of log 16 through band saw blade 46, a board of desired board thickness is separated from log 16. Subsequently, longitudinal conveyor 14 is displaced back again in the direction of an arrow 64, wherein band saw assembly 42 had been displaced before slightly away from log 16 in the direction of an arrow 66 (see FIG. 6), for avoiding a contact between band saw blade 46 and a cutting edge generated before on log 16.

When longitudinal conveyor 14 has passed band saw assembly 42, the latter is again displaced in the direction of an arrow 68 towards log 16, namely as far as during the feeding of log 16 through band saw blade 46, a board of the desired board thickness is separated from log 16 (see FIG. 7).

The afore-described pass is now repeated as often as necessary wherein, as soon as about one half of log 16 is cut away, log 16 is rotated between jaws 26 by 180° about its longitudinal axis. Moreover, it is also possible to again apply cross-cuts by means of cross-cut saw 32 between individual passes during which a board is separated from log 16. For that purpose, longitudinal conveyor 14 has simply to be brought into an appropriate longitudinal position and log 16 has to be advanced by means of transversal conveyor 20 to come as near to cross-cut saw 32 as necessary.

According to the method described before, the determination of the board thickness is exclusively made by displacing band saw assembly 42. However, as an alternative or in addition it may also be provided to move log 16 towards band saw assembly 42 by means of transversal conveyor 20.

1. A method for dissecting a log, the log being adapted to be reciprocally displaced on a longitudinal conveyor in a longitudinal direction, the method comprising the steps of:
a) displacing said log on said longitudinal conveyor in a transversal direction extending under right angles relative to said longitudinal direction towards a working tool, until said log assumes a transversal position relative to said working tool corresponding to a predetermined working depth;
b) before or simultaneously with said step of displacing said log on said longitudinal conveyor, displacing said band saw blade at least as much away from said log in said transversal direction that said log may be displaced on said longitudinal conveyor past said band saw blade without coming in contact with the band saw blade;
c) working said log from its periphery with said working tool; and
d) dissecting said log in said longitudinal direction by feeding said log in several passes through a band saw blade in said longitudinal direction.

2. The method of claim 1, wherein prior to each pass said band saw blade after step d) is displaced as much towards said log in said transversal direction that during said feeding of said log through said band saw blade a board of predetermined thickness is dissected from said log.

3. The method of claim 1, wherein after each dissecting of a board said band saw blade is displaced as much away from said log in said transversal direction that said log may be moved on said longitudinal conveyor past said band saw blade without coming in contact with said band saw blade.

4. The method of claim 2, wherein after each dissecting of a board said band saw blade is displaced as much away from said log in said transversal direction that said log may be moved on said longitudinal conveyor past said band saw blade without coming in contact with said band saw blade.

5. The method of claim 1, wherein said band saw blade is toothed on both sides in said longitudinal direction such that each longitudinal forward and backward movement configurates a pass in which a board is dissected from said log.

6. The method of claim 1, wherein in step c) said log is cross-cut in predetermined intervals along said log.

7. An apparatus for dissecting a log comprising:
a) a longitudinal conveyor on which a log may be displaced reciprocally in a longitudinal direction;
b) a transversal conveyor arranged on said longitudinal conveyor for displacing said log on said longitudinal conveyor in a transversal direction extending under right angles relative to said longitudinal direction;
c) a working tool for working said log from its periphery down to a predetermined working depth, said working depth being adapted to be set by displacing said transversal conveyor in said transversal direction;
d) a band saw blade for dissecting said log in said longitudinal direction by feeding said log in several passes through said band saw blade in said longitudinal direction;
e) means for displacing said band saw blade in said transversal direction; and
f) a control unit for controlling said longitudinal conveyor, said transversal conveyor, said working tool and said band saw blade, said control unit being configurated such that it displaces said band saw blade before or simultaneously with said displacement of said log on said longitudinal conveyor towards said working tool at least as much away from said log in said transversal direction that said log may be displaced on said longitudinal conveyor past said band saw blade without coming in contact with said band saw blade.

8. The apparatus of claim 7, wherein said control unit comprises a computer unit and a memory means with a computer program stored therein, said computer program being configurated such that said apparatus executes a method with the following steps:
a) displacing said log on said longitudinal conveyor in a transversal direction extending under right angles relative to said longitudinal direction towards a working tool, until said log assumes a transversal position relative to said working tool corresponding to a predetermined working depth;
b) before or simultaneously with said step of displacing said log on said longitudinal conveyor, displacing said band saw blade at least as much away from said log in said transversal direction that said log may be displaced on said longitudinal conveyor past said band saw blade without coming in contact with the band saw blade;
c) working said log from its periphery with said working tool; and
d) dissecting said log in said longitudinal direction by feeding said log in several passes through a band saw blade in said longitudinal direction,
when said computer program is loaded from said memory means into said computer unit.

9. The apparatus of claim 7, wherein said band saw blade is part of a band saw assembly, said band saw assembly being adapted to be displaced in said transversal direction.

10. The apparatus of claim 7, wherein said working tool is stationary.

11. The apparatus of claim 7, wherein said working tool is a cross-cut saw.
